(19) United States
(12) Patent Application Publication
(10) Pub. No.: US 2005/0242754 A1
(43) Pub. Date: Nov. 3, 2005

(54) Projection display apparatus and magnetic shield device

(75) Inventor: Kenichi Ooshima, Fukaya-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 10/619,560

(22) Filed: Jul. 16, 2003

(30) Foreign Application Priority Data
Jul. 17, 2002 (JP) 2002-208775

(51) Int. Cl. G09G 1/04

(52) U.S. Cl. 315/370; 315/371; 315/382.1; 315/382

(57) ABSTRACT

In a CRT-based projection display apparatus that displays on a screen video images displayed on three CRTs for red, green, and blue respectively, by projecting the video images against a screen so that the video images are enlarged and synthesized, a deflecting yoke and a velocity modulating coil are attached to a neck portion of each CRT. Furthermore, a cylindrical magnetic shield is arranged so as to cover a coil portion of the velocity modulating coil and a cathode of the CRT.

### CROSS-REFERENCE TO RELATED APPLICATIONS

This application is based upon and claims the benefit of priority from the prior Japanese Patent Application No. 2002-208775, filed Jul. 17, 2002, the entire contents of which are incorporated herein by reference.

### BACKGROUND OF THE INVENTION

1. Field of the Invention

The present invention relates to electronic equipment that uses a CRT (Cathode Ray Tube) as a display apparatus, and in particular, to a projection display apparatus and a magnetic shield device.

2. Description of the Related Art

In CRTs used for a television receiver or the like, an electron beam emitted by an electron gun is scanned in horizontal and vertical directions by a deflecting yoke to impinge against a fluorescent screen of each CRT. Another commonly known method is to provide a velocity modulating coil near the deflecting yoke to modulate an electron beam horizontal-scanning velocity in a luminance changing portion of a video in order to make the contour of the video signal clear.

In a case of common color CRTs, an electron gun emits three electron beams, which impinge against corresponding fluorescent screens at respective predetermined positions at respective predetermined intensities. Thus, red, green, and blue luminous elements each emit light at a desired luminance to display a color video image. In a television receiver with such common color CRTs, a neck portion of each CRT is horizontally installed. Accordingly, the scanning of electron beams is affected by ambient magnetic fields such as geomagnetism. As a result, an image displayed on the fluorescent screen may undergo raster distortion or misalignment.

Further, in addition to the above common television receivers, a projection display apparatus using a plurality of CRTs is popular. For example, a rear projection display apparatus is commonly provided with a red CRT that displays a red component of a video image, a green CRT that displays a green component of the video image, and a blue CRT that displays a blue component of the video image. Video images from the respective CRTs are projected against the rear surface of a screen via respective lenses. The video images are then synthesized on the screen.

With this rear projection display apparatus, the neck of the CRT is generally installed substantially vertically. Thus, the CRTs of the rear projection display apparatus are affected more easily than the common color CRTs by a change in external magnetic fields, notably in geomagnetism in a place where the apparatus is installed. That is, even when the rear projection display apparatus is relocated or its orientation is changed, its CRTs are markedly affected by a horizontal magnetic field component of the geomagnetism. On the screen against which the video images are projected, convergence misalignment may occur wherein red, green, and blue images are misaligned with respect to one another.

To suppress this misalignment, a magnetic shield shaped like a rectangular parallelepiped or a cylinder is installed in the neck portion of each CRD for red, green, or blue. A configuration of a color CRT with a magnetic shield provided in its neck portion is disclosed in, for example, Jpn. Pat. Appln. KOKAI Publication No. 7-115656.

If magnetic shields such as the one disclosed in the above publication are provided in a projection display apparatus, the above convergence misalignment is suppressed but the magnetic shields cannot produce sufficient effects. Consequently, the apparatus disclosed in the above publication is not satisfactorily effective in a practical sense.

Further, although a velocity modulating coil is generally attached to the CRT, the above publication does not suggest any shields for the velocity modulating coil or any methods for attaching the velocity modulating coil. Furthermore, the thickness and shape of the magnetic shield are restricted. Accordingly, large and heavy shields must be avoided.

### BRIEF SUMMARY OF THE INVENTION

According to one aspect of the invention, there is provided a projection display apparatus that synthesizes and displays video images on a screen, the video images being projected by a plurality of projection devices, the plurality of projection devices each comprising:

a CRT having an electron gun arranged in a neck portion to emit an electron beam from the electron gun to a luminous element; a deflecting yoke arranged around an outer periphery of the CRT to deflect the electron beam from the electron gun; a velocity modulating coil provided around the outer periphery of the neck portion of the CRT and between the deflecting yoke and the electron gun to modulate a horizontal scanning speed of the electron beam; and a cylindrical magnetic shield arranged around the outer periphery of the neck portion so as to cover an area from a cathode of the electron gun to the velocity modulating coil.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view showing the structure of an optical system in a CRT-based projection display apparatus according to an embodiment of the present invention;

FIG. 2 is a diagram showing the relationship between a CRT 12 and a lens 14 and a screen;

FIG. 3 is a view of a configuration of projection cathode-ray tubes, showing how the tubes are assembled together;

FIG. 4 is an exploded view showing a configuration of each projection cathode-ray tube;

FIG. 5 is a diagram showing a configuration of an electron gun 8 provided in a neck portion 12a of the CRT 12;

FIG. 6 is a perspective view showing the neck portion 12a of the projection cathode-ray tube 1;

FIG. 7 is a diagram showing a configuration of the neighborhood of a magnetic shield in detail;

FIG. 8 is a perspective view of the magnetic shield 3;

FIGS. 9A, 9B, and 9C are a plan view, a side view, and a front view of the magnetic shield, respectively;

FIGS. 10A and 10B are a side view and a plan view of a velocity modulating coil 7;

FIG. 11 is a perspective view showing how the magnetic shield 3, the velocity modulating coil 7, and a velocity modulating circuit board 6 are attached to one another; and

FIG. 12 is a diagram showing how the magnetic shield 3, the velocity modulating coil 7, and the velocity modulating circuit board 6 are attached to the CRT neck portion 12a.

### DETAILED DESCRIPTION OF THE INVENTION

An embodiment of the present invention will be described below with reference to the drawings.

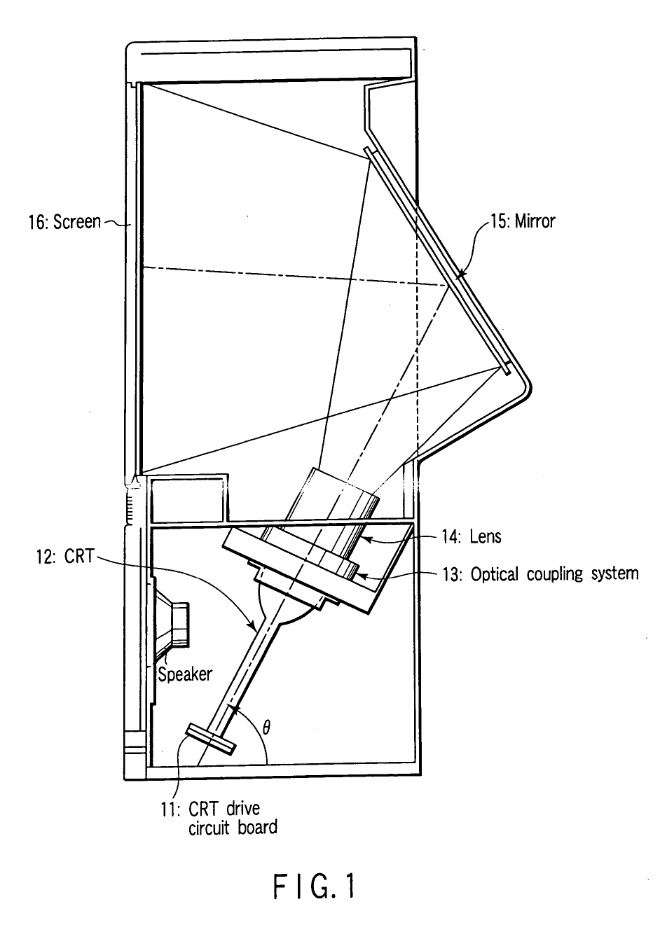

FIG. 1 is a sectional view showing a CRT-based projection display apparatus according to an embodiment of the present invention. This figure schematically shows the entire structure of the optical system. In this figure, a deflecting yoke, a velocity modulating coil, a shield plate, and the like, described later, are omitted.

In FIG. 1, a CRT drive circuit board 11 is attached to a CRT 12 so that the CRT 12 is driven by a video signal supplied by the drive circuit board 11. Thus, a corresponding video image is displayed on a fluorescent screen of the CRT 12. The video image displayed on the fluorescent screen of the CRT 12 is incident on a lens 14 via an optical coupling system 13. The optical coupling system 13 is filled with a coolant to absorb heat generated when the CRT 12 is operated.

The video incident on the lens 14 is enlarged and is then reflected by a mirror 15. It then reaches the rear surface of a screen 16. The video image displayed on the fluorescent screen of the CRT 12 is enlarged when displayed on the screen 16. Thus, a user can view the video image on the surface of the screen 16.

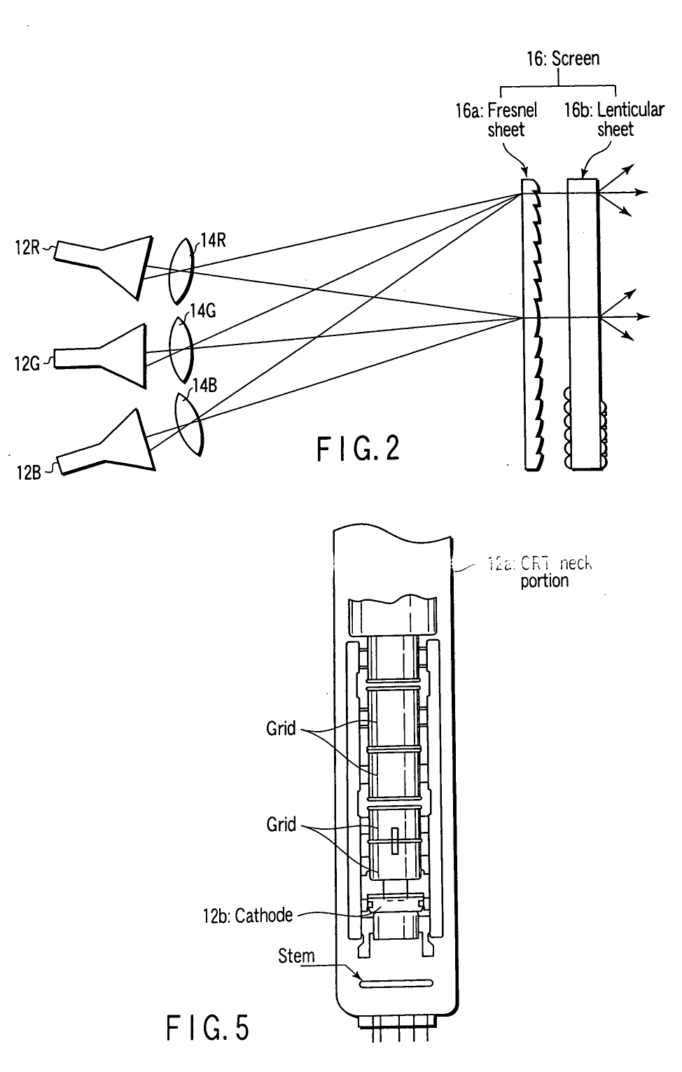

FIG. 2 is a view showing the relationship between the CRT 12 and the lens 14 and the screen. The CRT 12 is composed of three CRTs (12R, 12G, and 12B) for red, green, and blue, respectively. The CRT 12R displays a video image of a red component, the CRT 12G displays a video image of a green component, and the CRT 12B displays a video image of a blue component. The video images displayed on the CRT 12R, CRT 12G, and CRT 12B are enlarged by lenses 14R, 14G, and 14B, respectively, and then reach the screen 16.

The screen 16 is composed of a Fresnel sheet 16a and a lenticular sheet 16b. Concaves and convexes formed on the Fresnel sheet 16a refract light traveling toward a peripheral portion of the screen, in the direction of a G axis (toward the center of the screen) owing to the effect of a convex lens. Light transmitted through the Fresnel sheet 16a passes through the lenticular sheet 16b. Convex portions formed on the lenticular sheet 16b widen the horizontal directivity of light passed through the lenticular sheet.

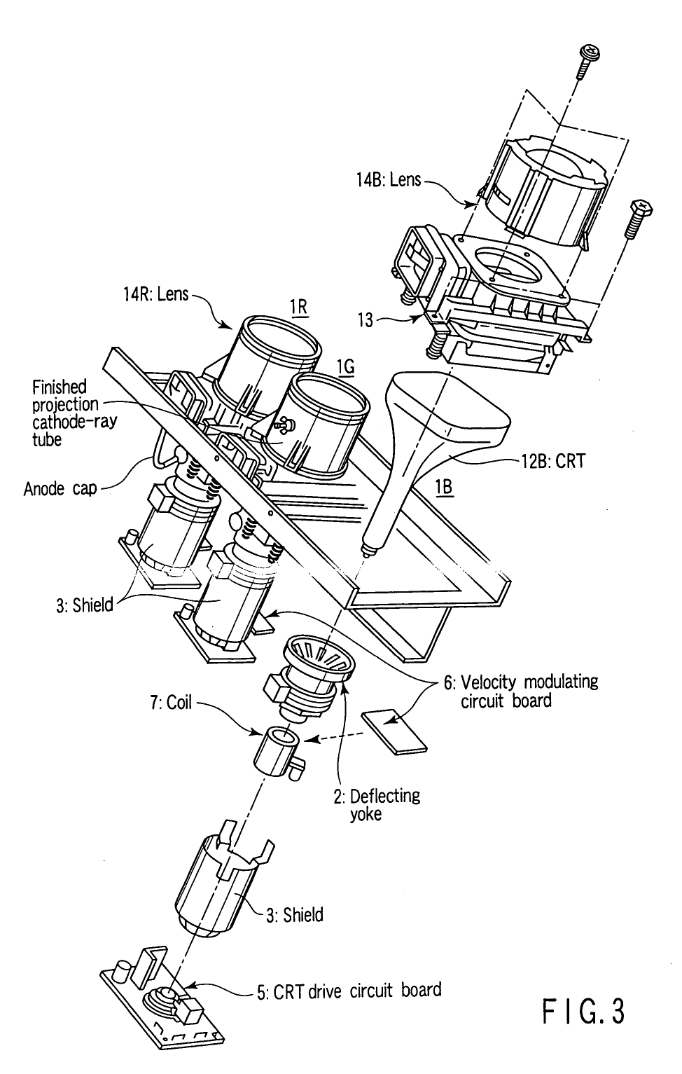

FIG. 3 is a perspective view showing a configuration of projection devices used in a rear projection display apparatus according to the present embodiment. This projection display apparatus is composed of three projection devices 1R, 1G, and 1B. Each of the projection devices 1R, 1G, and 1B includes a CRT drive circuit board 5, a magnetic shield 3, a velocity modulating coil 7, a velocity modulating circuit board 6, a deflecting yoke 2, and a CRT 12. Each of the projection devices 1R, 1G, and 1B has an optical coupling system 13, a lens 14, and the like. FIG. 3 shows the projection devices 1R and 1G assembled, while the projection device 1B is disassembled.

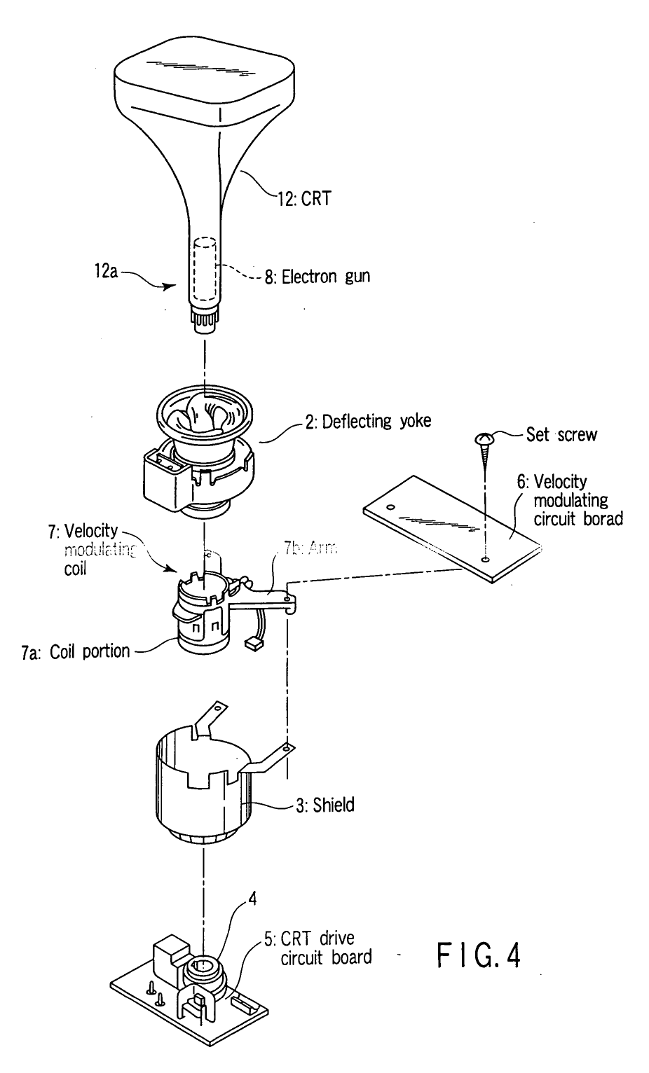

FIG. 4 is an exploded view illustrating essential parts of one of the three projection devices. The projection device in FIG. 4 includes the CRT drive circuit board 5, the magnetic shield 3, the velocity modulating coil 7, the velocity modulating circuit board 6, the deflecting yoke 2, and the CRT 12. The illustration of the optical coupling system 13, the lens 14, and the like is omitted.

The CRT 12 has a neck portion 12a passing through the deflecting yoke 2, velocity modulating coil 7, and magnetic shield 3 and connected to a socket 4 provided on the CRT drive circuit board 5. The velocity modulating coil 7 has a coil portion 7a accommodated in the magnetic shield 3 and an arm 7b to which the velocity modulating circuit board 6 is fixed using set screws. The velocity modulating coil 7 is fixed to the neck portion 12a of the CRT 12.

FIG. 5 is a diagram showing a configuration of an electron gun 8 provided in the neck portion 12a of the CRT 12. An electron beam emitted by a cathode 12b passes between grids while being controlled by a grid voltage applied to the grids. The electron beam is then emitted toward a display surface of the CRT 12 to which a high voltage is applied.

The electron beam is scanned in horizontal and vertical directions by the deflecting yoke 2. Further, a velocity modulating circuit mounted on the velocity modulating circuit board 6 generates an auxiliary deflecting current for a linear differential waveform of a video signal. When the auxiliary deflecting current flows through the coil 7, the horizontal scanning speed of the electron beam is modulated by a portion of the video signal in which luminance changes. As a result, the contour of the video signal becomes clear.

FIG. 6 is a perspective view showing the neck portion of the projection device 1 into which the components have been integrated. In the projection device 1 according to the present embodiment, the magnetic shield 3 is provided so as to entirely cover the coil portion 7a of the velocity modulating coil 7 and the cathode 12b. In an area in which electrons move at their initial velocity or a velocity close to it, that is, in the area between the cathode 12b and the deflecting yoke 2, the electrons are most likely to be affected by external magnetic fields. The convergence performance can be significantly improved by magnetically shielding this portion.

The magnitude of magnetic shielding effected by the magnetic shield 3 is expressed by:
S=μ×t/d

where μ is the magnetic permeability of the shield material,

t is the thickness of the shield, and

d is the diameter of the shield.

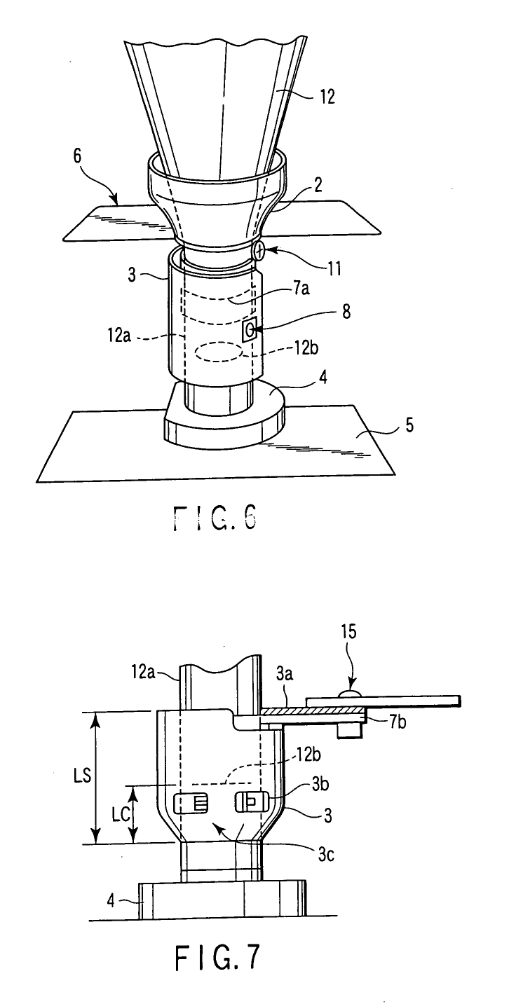

FIG. 7 is a diagram showing a configuration of the neighborhood of the magnetic shield 3. The dimension Ls of the magnetic shield 3 in the electron beam moving direction is sufficient to entirely cover the coil portion 7a of the velocity modulating coil 7 and the cathode 12b as described above. If the distance between the end of the magnetic shield (the lower end of the figure) and the cathode 12b is defined as Lc, then the magnetic shield 3 is provided on the CRT neck portion 12a so that Lc/Ls is between ¼ and ⅓ in order to obtain a sufficient magnetic shielding effect.

Further, a constricted portion 3c is formed at the end of the magnetic shield 3 to block external magnetic fields from the CRT drive circuit board 5. Furthermore, the lower part of the constricted portion 3c is extended to the outer peripheral surface of the CRT neck portion 12a to prevent the lower part of the magnetic shield 3 from shaking relative to the CRT neck portion.

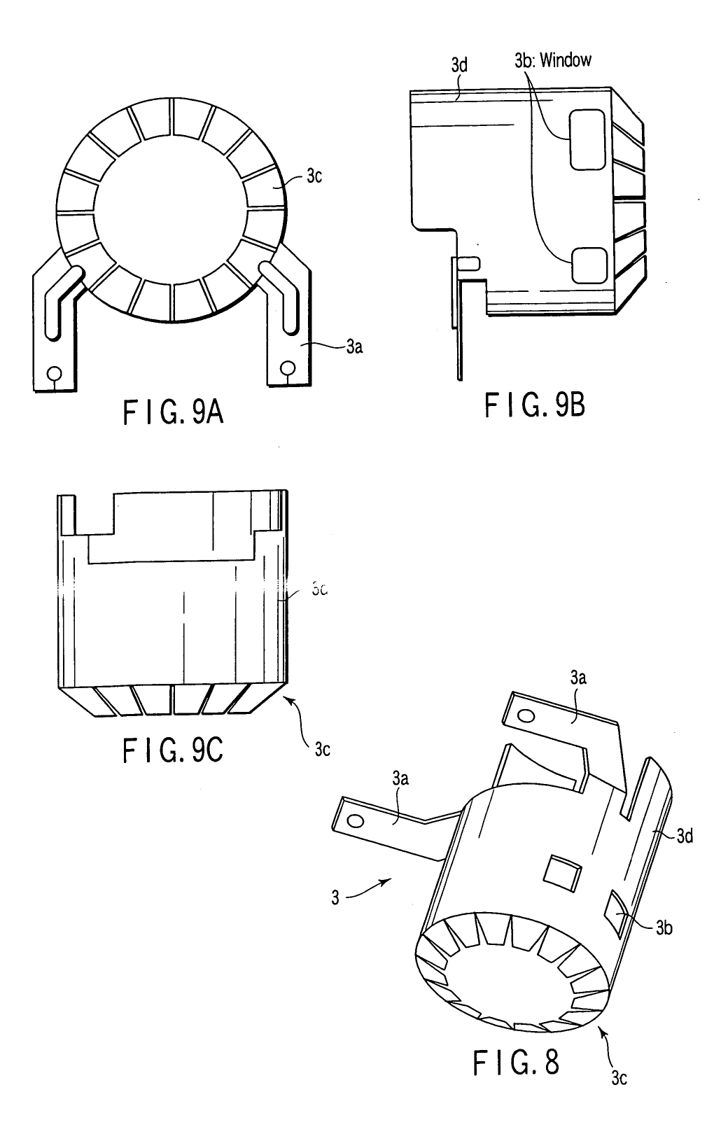

FIG. 8 is a perspective view of the magnetic shield 3 as viewed from below. FIG. 9A is a plan view, FIG. 9B is a side view, and FIG. 9C is a front view. As shown in FIGS. 8 and 9, the magnetic shield 3 is provided with a cylindrical main body portion 3d, stays 3a formed to extend radially from one end of the main body portion, a window 3b, and a constriction 3c which extends from the other end of the main body portion and which has a gradually decreasing inner diameter. The dimension of the constriction 3c in the direction of the central axis of the main body portion 3d is substantially equal to Lc, described above.

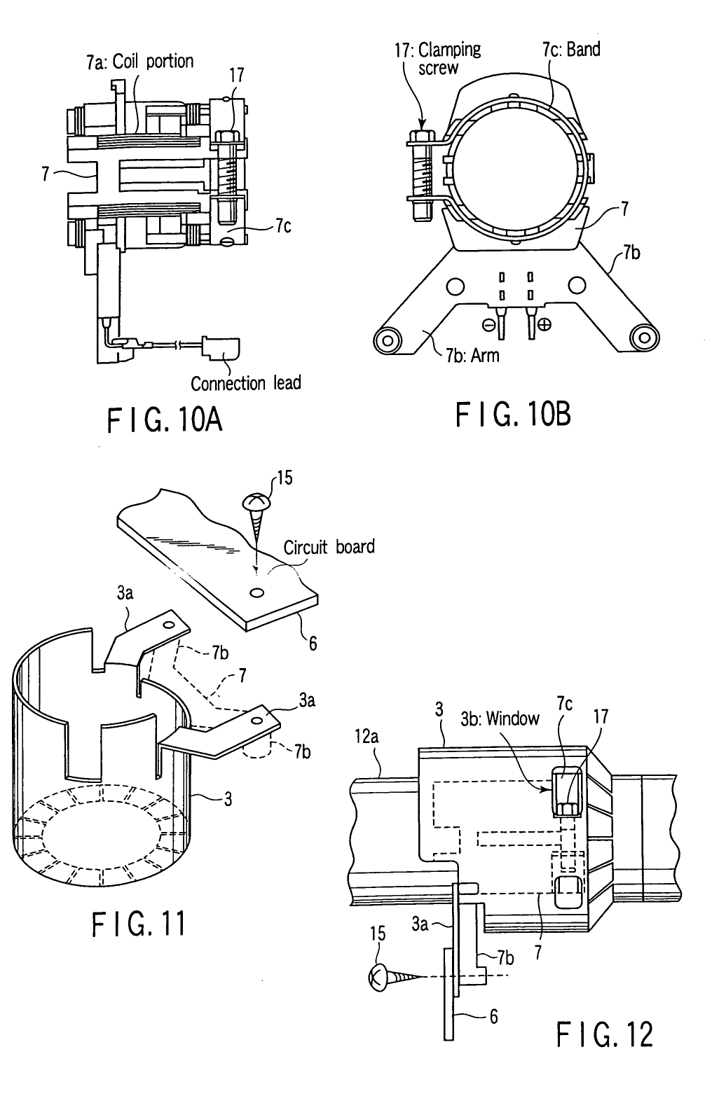

FIGS. 10A and 10B are a side view and a plan view, respectively, of the velocity modulating coil 7. The velocity modulating coil 7 includes the coil 7a, the arm 7b, a band 7c, and a clamping screw 17.

FIG. 11 is a perspective view showing how the magnetic shield 3, the velocity modulating coil 7, and the velocity modulating circuit board 6 are attached to one another. The velocity modulating coil 7 and the velocity modulating circuit board 6 are attached to the stays 3a of the magnetic shield 3 using screws 15 (fixtures). As shown in FIG. 7, the velocity modulating circuit board 6 and the arm 7b of the velocity modulating coil are fixed so as to sandwich the stays 3a of the magnetic shield between themselves. A copper foil pattern for the ground potential for the velocity modulating circuit board 6 is arranged where the velocity modulating circuit board 6 and each of the stays 3a contact with each other: the copper foil pattern is exposed from this portion. As a result, the ground potential pattern of the velocity modulating circuit board 6 and the stays 3a of the magnetic shield 3 contact directly with each other. The magnetic shield 3 is then connected to a ground circuit pattern of the CRT drive circuit board 5. This eliminates the need for conventional aerial wires required to connect the magnetic shield 3 and the ground pattern of the CRT drive circuit board 5 together.

FIG. 12 is a diagram showing how the magnetic shield 3, velocity modulating coil 7, and velocity modulating circuit board 6 are attached to the CRT neck portion 12a. The velocity modulating coil 7 is fixed to the outer periphery of the CRT neck portion 12a by clamping the band 7c using the screw 17. The screw 17 can be rotated by inserting an appropriate tool through the window 3b in the magnetic shield 3.

In the CRT-based rear projection display apparatus, the CRT neck is installed so as to stand substantially vertically as shown in FIG. 1. Accordingly, the CRT is likely to be affected by a change in external magnetic fields, notably in geomagnetism. As a result, even when the rear projection display apparatus is relocated or its orientation is changed, the CRT is markedly affected by the horizontal magnetic field component of geomagnetism. On the screen, convergence misalignment may occur wherein red, green, and blue images are misaligned with respect to one another. To suppress this misalignment, the CRT-based rear projection display apparatus has the above cylindrical magnetic shield installed in the neck portion of each CRT for red, green, and blue.

The CRT 12 is integrated into the CRT-based rear projection display apparatus at an attaching angle (see FIG. 1) of 40 to 90° to the horizontal direction. However, even if the CRT is provided at a predetermined angle to the vertical direction in this manner, the magnetic shield 3 of the present invention can prevent the adverse effects of geomagnetism. Therefore, the adverse effects of external magnetic fields such as convergence misalignment can be significantly suppressed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A projection display apparatus that synthesizes and displays video images on a screen, the video images being projected by a plurality of projecting devices, the plurality of projecting devices each by comprising:
a CRT (Cathode Ray Tube) having a neck portion, a fluorescent screen, and an electron gun arranged in the neck portion and including a cathode, the CRT emitting an electron beam from the electron gun to the fluorescent screen;
a deflecting yoke arranged around an outer periphery of the CRT to deflect the electron beam from the electron gun;
a velocity modulating coil provided around the outer periphery of the neck portion of the CRT and between the deflecting yoke and the cathode to modulate a horizontal scanning speed of the electron beam; and
a cylindrical magnetic shield arranged around the outer periphery of the neck portion so as to cover an area from a cathode portion of the electron gun to the velocity modulating coil.

2. A projection display apparatus according to claim 1, wherein the magnetic shield has a main body portion shaped like a cylinder which is concentric with an outer diameter of the neck portion and surrounding the velocity modulating coil, and a constricted portion extending from the main body portion toward an edge of the neck portion and having a gradually decreasing diameter, the constricted portion being formed so as to cover a periphery of the cathode of the electron gun.

3. A projection display apparatus according to claim 1, wherein when an axial dimension of the main body portion is defined as Ls and an axial dimension of the constricted portion is defined as Lc, the magnetic shield is formed so that Lc/Ls is between ¼ and ⅓.

4. A projection display apparatus that synthesizes and displays video images on a screen, the video images being projected by projecting devices for red, green, and blue, the plurality of projecting devices each comprising:
a CRT (Cathode Ray Tube) having a neck portion, a fluorescent screen, and an electron gun arranged in the neck portion and including a cathode, the CRT emitting an electron beam from the electron gun to the fluorescent screen;
a deflecting yoke arranged around an outer periphery of the CRT to deflect the electron beam from the electron gun;
a velocity modulating coil provided around the outer periphery of the neck portion of the CRT and between the deflecting yoke and the cathode to modulate a horizontal scanning speed of the electron beam;
a cylindrical magnetic shield having a cylindrical shield main body arranged around the outer periphery of the neck portion so as to cover an area from a cathode portion of the electron gun to the velocity modulating coil, and stays formed to extend from one end of the shield main body arranged around the outer periphery of the neck portion;
a circuit board to drive the velocity modulating coil; and
fixtures to attach the circuit board to the stays.

5. A projection display apparatus according to claim 4, wherein the circuit board to drive the velocity modulating coil has a ground pattern and is fixed to the stays so that the ground pattern contacts with the stays of the magnetic shield.

6. A projection display apparatus according to claim 4, wherein an arm is integrally formed at one end of the velocity modulating coil so as to lie opposite the stays, and the arm, the stays, and the circuit board are fixed together using the fixtures so that the stays are sandwiched between the arm and the circuit board.

7. A projection display apparatus according to claim 4, wherein the velocity modulating coil is attached to an outer periphery of the neck portion using a clamping band and a screw, and a window is formed in the magnetic shield so that the screw can be adjusted through the window.

8. A magnetic shield device for a CRT having an electron gun arranged in a neck portion of the CRT, the magnetic shield device comprising:
a cylindrical main body portion which can be attached to an outer periphery of the neck portion, has an inner diameter larger than an outer diameter of the neck portion, and covers an area of the electron gun except for a cathode portion; and
a constricted portion which extends from one end of a electron gun side of the main body portion, has a gradually decreasing diameter, and covers the cathode portion of the electron gun.
